(19) United States
(12) Patent Application Publication
(10) Pub. No.: US 2025/0219077 A1
(43) Pub. Date: Jul. 3, 2025

(54) Manufacturing Water based Low-tortuosity Electrodes for Fast-charge through Pattern Integrated Calendaring

(71) Applicant: Northeastern University, Boston, MA (US)

(72) Inventor: Hongli Zhu, Newton, MA (US)

(21) Appl. No.: 18/589,368

(22) Filed: Feb. 27, 2024

Related U.S. Application Data
(60) Provisional application No. 63/487,361, filed on Feb. 28, 2023.

(51) Int. Cl. H01M 4/58; H01M 4/02; H01M 4/04; H01M 4/62; H01M 4/66

(52) U.S. Cl. CPC H01M 4/5825; H01M 4/0404; H01M 4/0435; H01M 4/622; H01M 4/625; H01M 4/661; H01M 2004/021

(57) ABSTRACT

Achieving high energy density and fast charging of lithium-ion batteries can accelerate the adoption of electric vehicles. However, the increased mass and poor charge transfer properties of existing electrodes impede the electrochemical reaction kinetics and limit the battery charging speed. Herein is demonstrated a novel stamping process to create channels in electrode material that accelerate ion transport and increase rate performance of the electrode. Pressure applied during the stamping process improved the mechanical stability of the electrode and its contact with the current collector. The stamped low-tortuosity LiFePO₄ electrode demonstrated a higher discharge capacity compared to a conventional electrode with the same thickness of 155 μm at high rate (101 mAh/g and 16 mAh/g, respectively, at a rate of 3 C) and superior stability. The stamping method offers unparalleled possibilities for industrial applications, owing to its simplicity, scalability, low cost and solvent consumption, and waste reduction.

### RELATED APPLICATION(S)

This application claims the benefit of U.S. Provisional Application No. 63/487,361, filed on Feb. 28, 2023. The entire teachings of the above application(s) are incorporated herein by reference.

### GOVERNMENT SUPPORT

This invention was made with government support under Grant Number DE-EE0009111 awarded by the Department of Energy. The government has certain rights in the invention.

### BACKGROUND

The development of lithium-ion batteries (LIBs) with high energy densities and long cycle lives is crucial for increasing the range of electric vehicles (EVs).^{[1]} In addition, fast-charging LIBs with high mass loading are essential for meeting the growing energy requirements of EVs.^{[2]} Currently, the factors that limit the LIB charging speed are the low mass-transfer ability of the electrolyte^{[3]} and the slow ion transport in conventional electrodes, which hinder the overall ion diffusion rate.^{[4]} During fast charging, lithium ions are depleted at a certain depth from the electrode surface, beyond which the active material cannot be utilized. Therefore, electrodes with low mass loading are preferred for fast charging applications.^{[5]} However, low mass loading leads to a reduced areal energy density, which impedes improvement of the mile range of EVs.^{[6]} Current state-of-the-art research focuses primarily on electrolyte engineering and electrode structure modification to solve this problem.^{[7]}

### SUMMARY

An example embodiment is an electrode, comprising: a current collector; and an electrode material coupled to the current collector, the electrode material containing microchannels and depth of microchannels is less than thickness of the electrode material.

In an aspect, the electrode material has a hydrophilic surface with a water contact angle equal to or less than about 60°.

In an aspect, depth of the microchannels is from about 50 μm to about 150 μm.

In another aspect, diameter of the microchannels is from about 50 μm to about 150 μm.

In another aspect, the diameter of the microchannels is about 120 μm, and depth of the microchannels is about 71 μm.

In another aspect, the electrode has a specific discharge capacity of at least about 90 mAh/g at a current rate of about 3 C.

In another aspect, the electrode has an areal mass loading of at least about 10 mg/cm².

In yet another aspect, the thickness of the electrode material is equal to or less than about 250 μm.

Another example embodiment is a method of forming an electrode, comprising: a) loading a pattern on a stamp surface, the pattern defining microchannels of the electrode; b) adding an electrode slurry to the stamp surface; c) pressing the stamp surface onto a current collector to transfer the electrode slurry onto the current collector; and d) drying the electrode slurry to produce an electrode material containing the microchannels with depth less than thickness of the electrode material, thereby forming the electrode comprising the current collector and the electrode material coupled to the current collector.

In an aspect, the stamp has a back at a location apart from the stamp surface, and adding an electrode slurry to the stamp surface comprises applying a normal force at the back of the stamp.

In another aspect, the pattern is a hexagonal pattern.

In another aspect, the pattern comprises cylinders having diameter of from about 50 μm to about 150 μm.

In another aspect, the stamp is a stamp roller and pressing the stamp surface onto the current collector comprises using a pressure roll and the stamp roller to transfer the slurry from the stamp roller to the current collector.

In another aspect, solid content of the slurry is from about 60% to about 70%.

In another aspect, material composing the current collector is stainless steel, titanium, aluminum, nickel, or copper, or a combination thereof.

In an embodiment is an electrode slurry, comprising active material, electrically conductive material, and binder.

In an aspect, the active material comprises LiFePO₄.

In another aspect, solid content of the slurry is from about 60% to about 70%.

In another aspect, the electrically conductive material is carbon black, and the binder comprises carboxymethyl cellulose sodium salt (CMC) and styrene-butadiene rubber (SBR).

In another aspect, the active material, electrically conductive material, and binder are in a weight ratio of about 87:10:3.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A: Schematic representation of conventional bar-coated electrode structure.

FIG. 1B: Schematic representation of stamped low-tortuosity electrode structure.

FIG. 1C: Fabrication of low-tortuosity electrode using the stamping method.

FIG. 1D: Scaling up of the stamping method for industrial R2R manufacturing.

FIG. 2: Stamp pattern arrangement.

FIG. 3A: 40 wt. % solid content dispersed electrode slurry flowability.

FIG. 3B: 65 wt. % solid content dispersed electrode slurry flowability.

FIG. 4: Dispersed electrode slurry and electrode material composition (LFP:Super P:CMC/SBR=87:10:3).

FIG. 5A: Stamped electrode fabricated by 65 wt. % solid content slurry.

FIG. 5B: Stamped electrode fabricated by 40 wt. % solid content slurry.

FIG. 6A: High-speed camera image of separation with 65% solid content slurry with slight separate angle.

FIG. 6B: High-speed camera image of separation with 65% solid content with large separate angle.

FIG. 6C: High-speed camera image of separation with 40% solid content with slight separate angle.

FIG. 6D: High-speed camera image of separation with 40% solid content with large separate angle.

FIG. 7A: Photographs of stamped electrodes of electrode material thickness 150 μm, 200 μm, and 250 μm.

FIG. 7B: Photographs of bar-coated electrodes of electrode material thickness 150 μm, 200 μm, and 250 μm.

FIG. 7C: Electrolyte absorption time of a stamped electrode.

FIG. 7D: Electrolyte absorption time of a bar-coated electrode.

FIG. 8A: Bar-coated electrode with an electrode material thickness of 200 μm after drying.

FIG. 8B: Bar-coated electrode with an electrode material thickness of 250 μm after drying.

FIG. 9A: Water contact angle of a stamped electrode (1 second after contact).

FIG. 9B: Water contact angle of a bar-coated electrode (1 second after contact).

FIG. 10A: SEM image of a top-view of a stamped electrode. The scale bar is 200 μm.

FIG. 10B: SEM image of a top-view of a stamped electrode. The scale bar is 100 μm.

FIG. 10C: SEM image of a top-view of a stamped electrode. The scale bar is 5 μm.

FIG. 10D: SEM image of a cross-section of a stamped electrode. The scale bar is 200 μm.

FIG. 10E: SEM image of a cross-section of a stamped electrode. The scale bar is 100 μm.

FIG. 10F: SEM image of a cross-section of a stamped electrode. The scale bar is 5 μm.

FIG. 10G: SEM image of a top-view of a conventional bar-coated electrode. The scale bar is 200 μm.

FIG. 10H: SEM image of a cross-section of a conventional bar-coated electrode. The scale bar is 100 μm.

FIG. 10I: High-magnification image of a conventional bar-coated electrode. The scale bar is 5 μm.

FIG. 11A: Electrochemical measurements of cells fabricated using stamped and bar-coated-T electrodes. EIS data of stamped and bar-coated-T electrodes.

FIG. 11B: EIS data of stamped electrodes with different electrode material thicknesses.

FIG. 11C: CV curves of stamped and bar-coated-T electrodes at a scan rate of 0.1 mV/s.

FIG. 11D: Voltage profile comparison for cells fabricated using stamped and bar-coated-T electrodes at 0.1 C.

FIG. 11E: Voltage profile comparison for cells fabricated using stamped and bar-coated-T electrodes at 2 C.

FIG. 11F: Voltage profile comparison for cells fabricated using stamped and bar-coated-T electrodes at 3 C.

FIG. 11G: Rate capability at various rates from 0.1 to 3 C.

FIG. 11H: Cycling performance of stamped and bar-coated-T electrodes at a current density of 1 C.

FIG. 12: Voltage profile comparison for stamped and bar-coated-T electrode batteries at 1 C.

FIG. 13A: Voltage profile for the third cycle at different current rates for stamped electrode.

FIG. 13B: Voltage profile for the third cycle at different current rates for bar-coated electrode.

FIG. 14: Charge capacities for stamped electrode, bar-coated-T electrode (same electrode material thickness) and bar-coated-M electrode (same areal mass loading) at current rate from 0.1 C to 3 C.

FIG. 15: Areal capacity for stamped and bar-coated-M electrodes at current rate from 0.1 C to 3 C.

FIG. 16A: EIS data of a stamped electrode before and after the cycling test.

FIG. 16B: EIS data of a bar-coated electrode before and after the cycling test.

FIG. 16C: Photograph of a stamped electrode after the cycling test.

FIG. 16D: Photograph of a bar-coated electrode after the cycling test.

FIG. 16E: SEM top-view image of a stamped electrode after the cycling test.

FIG. 16F: SEM cross-sectional image of a stamped electrode after the cycling test.

FIG. 16G: SEM top-view of a bar-coated electrode after the cycling test.

FIG. 16H: SEM cross-sectional image of a bar-coated electrode after the cycling test.

FIG. 17: Bar-coated electrode top-view SEM images after the cycling test.

The foregoing will be apparent from the following more particular description of example embodiments, including those illustrated in the drawings interspersed herein. The drawings are not necessarily to scale, emphasis instead being placed upon illustrating embodiments.

### DETAILED DESCRIPTION

A description of example embodiments follows.

Low-tortuosity electrodes accelerate the diffusion of lithium ions and provide the shortest path for ion transport. Additionally, the porous electrode surface enhances electrolyte absorption and improves the mass transfer of reactants^{[8]}. Several methods have been reported recently for the fabrication of low-tortuosity electrodes, such as magnetic alignment^{[9]}, laser perforation^{[10]}, 3D printing^{[11]}, and the utilization of organic structures, such as wood^{[12]}. Despite their better rate performance and stability compared to bar-coated electrodes, the fabrication of low-tortuosity electrodes using the aforementioned methods is time-consuming and expensive. For example, the magnetic alignment method introduces magnetic impurities into the electrode, which requires additional processing steps for their removal. The high cost and complexity of the fabrication process, together with its low efficiency, hindered its adoption for industrial production.

In contrast to the aforementioned methods, the simple and adaptable stamping method described herein is capable of producing low-cost low-tortuosity electrodes. This technology enables the direct transfer of the electrode slurry onto the current collector by exploiting the adhesion between the two materials and the fluidity of the slurry. When stamping slurry with poor flowability, the pattern created on the electrode can be damaged after the stamp separation owing to the slurry flow. By taking advantage of the stronger adhesion between the electrode slurry and current collector, the slurry and stamp can be separated without material loss, leaving the patterned electrode intact. Furthermore, owing to the simplicity of the stamping method, the fabrication time is similar to that of the conventional coating techniques. In addition, the applied pressure during the stamping process simulates the normal force during the calendaring treatment in the traditional fabrication processes. The applied pressure enhances the contact between the particles in the electrode material, thus improving the electrode conductivity and rate performance. It also optimizes the contact between the electrode and current collector, ensuring better charge transfer, mechanical and structural stability, and improved cycling life and rate performance of the battery.^{[13]}

Herein, a simple stamping process was employed to fabricate low-tortuosity electrodes. The effect of the electrode structure on the fast-charging properties of the electrode was then evaluated. Compared to conventional bar-coated electrodes, stamped electrodes exhibit outstanding improvements in electrolyte wettability, charge-discharge capacity retention at high currents, and cycling performance. These advantages can be attributed to the unique electrode structure defining uniformly-arranged microchannels and the tight packing of the electrode material caused by the pressure applied during the stamping process. This work provides a new route for the design and fabrication of low-tortuosity fast-charging electrodes that can be implemented in conventional roll-to-roll (R2R) manufacturing.

The present disclosure generally relates to electrodes comprising current collector and electrode material, methods of forming the electrodes, and compositions (e.g., electrode slurry) for forming the electrodes. In embodiments, the electrode material comprises active material, electrically conductive material, and binder. The electrodes of the present disclosure may contain microchannels. As used herein, microchannels refer to electrode channel diameters in the micron range (e.g., between about 1 μm to about 1000 μm). The microchannels help decrease the ion transport pathway within the electrode, thereby accelerating the mass transport of the electrolyte and reducing the tortuosity of the electrode. In embodiments, the electrode is an electrode formed by a stamping process (e.g., R2R stamping). The stamping process may be combined with one or more processes including and not limited to calendering, reel-to-reel, web-fed continuous processing, and roll-to-roll (R2R) processes. In embodiments, the electrode is a stamped electrode. In some embodiments, the electrode is a R2R stamped electrode.

The electrode of the present disclosure may be a cathode or anode of an electrochemical cell (e.g., lithium-ion battery). In a lithium-ion rechargeable battery, lithium ions are stored at the anode during the charging process. Discharging takes place and electric current is generated when lithium ions move from the anode to the cathode through the Li-ion conducting liquid electrolyte system.

The electrode channels may be arranged in a hexagonal, staggered or parallel configuration. In embodiments, the channels are arranged in a hexagonal configuration.

The depth of the electrode channels (e.g., microchannels), for non-limiting example, is from about 1 μm to about 300 μm, about 1 μm to about 200 μm, about 10 μm to about 200 μm, about 20 μm to about 200 μm, about 30 μm to about 200 μm, about 40 μm to about 200 μm, about 50 μm to about 200 μm, about 50 μm to about 190 μm, about 50 μm to about 180 μm, about 50 μm to about 170 μm, about 50 μm to about 160 μm, about 50 μm to about 150 μm, about 50 μm to about 140 μm, about 50 μm to about 130 μm, about 50 μm to about 120 μm, about 50 μm to about 110 μm, about 50 μm to about 100 μm, about 50 μm to about 90 μm, about 50 μm to about 80 μm, about 60 μm to about 80 μm, about 70 μm to about 80 μm, or about 70 m to about 75 μm. In embodiments, the channel depth is about 71 μm.

The diameter of the electrode channels (e.g., microchannels), for non-limiting example, is from about 1 μm to about 300 μm, about 1 μm to about 250 μm, about 1 μm to about 200 μm, about 1 μm to about 190 μm, about 1 μm to about 180 μm, about 1 μm to about 170 μm, about 1 μm to about 160 μm, about 1 μm to about 150 μm, about 10 μm to about 150 μm, about 20 μm to about 150 μm, about 30 μm to about 150 μm, about 40 μm to about 150 μm, about 50 m to about 150 μm, about 50 μm to about 140 μm, about 50 μm to about 130 μm, about 60 μm to about 130 μm, about 70 μm to about 130 μm, about 80 μm to about 130 μm, about 90 μm to about 130 μm, about 100 μm to about 130 μm, or about 110 μm to about 130 μm. In embodiments, the channel diameter is about 120 μm. In some embodiments, the electrode of the present disclosure comprises microchannels with channel diameter of about 120 μm and channel depth of about 71 μm.

In some embodiments, the diameter of the electrode channel may be smaller (e.g., in an amount of from about 1 μm to about 20 μm, about 1 μm to about 15 μm, about 1 μm to about m, or about 1 μm to about 5 μm) at a proximal location (e.g., at a distance of from about 0 m to about 5 μm, about 0 μm to about 4 μm, about 0 μm to about 3 μm, about 0 μm to about 2 m, or about 0 μm to about 1 μm) from the current collector than the diameter of the channel at a distal location (e.g., at a distance of from about 100 μm to about 250 μm, about 100 μm to about 200 μm, or about 100 μm to about 150 μm) from the current collector.

In some embodiments, the electrode material has a hydrophilic surface. The water contact angle of the electrode material, for non-limiting example, is equal to or less than about 60°, equal to or less than about 50°, equal to or less than about 40°, or equal to or less than about 35°. The water contact angle of the electrode of the present disclosure is, for non-limiting example, from about 0° to about 60°, about 0° to about 50°, about 0° to about 40°, about 5° to about 40°, about 100 to about 40°, about 150 to about 40°, about 200 to about 40°, about 250 to about 40°, about 300 to about 40°, about 330 to about 37°, or about 340 to about 36°. In some embodiments, the water contact angle of the electrode of the present disclosure is about 35°.

The thickness of the electrode material, for non-limiting example, is equal to or less than about 250 μm, equal to or less than about 240 μm, equal to or less than about 230 μm, equal to or less than about 220 μm, equal to or less than about 210 μm, or equal to or less than about 200 μm. The thickness of the electrode material is, for non-limiting example, from about 10 μm to about 250 μm, about 50 μm to about 250 μm, about 60 μm to about 250 μm, about 70 μm to about 250 μm, about 80 μm to about 250 μm, about 90 μm to about 250 μm, about 100 μm to about 250 μm, about 110 μm to about 250 μm, about 120 μm to about 250 μm, about 130 μm to about 250 μm, about 140 μm to about 250 μm, about 150 μm to about 250 μm, about 150 μm to about 240 μm, about 150 μm to about 230 μm, about 150 μm to about 220 μm, about 150 μm to about 210 μm, or about 150 μm to about 200 μm. In some embodiments, the thickness of the electrode material is about 150 μm, about 155 μm, about 200 μm, or about 250 μm.

In embodiments, the thickness of the current collector (e.g. aluminum foil) is in an amount of from about 5 μm to about 50 μm (e.g., about 10 μm to about 50 μm, about 10 μm to about 40 μm, about 15 μm to about 40 μm, about 20 μm to about 40 μm, about 20 μm to about m, or about 25 μm to about 35 μm). In some embodiments, the thickness of the current collector (e.g. aluminum foil) is about 30 μm.

In embodiments, the depth of electrode channels (e.g., microchannels) is less than the thickness of the electrode material. For non-limiting example, the depth of the channels is less than the thickness of the electrode material, with a difference in an amount of from about 1 μm to about 200 μm, about 10 μm to about 200 μm, about 20 μm to about 200 μm, about 30 μm to about 200 μm, about 40 μm to about 200 μm, about 50 μm to about 200 μm, about 60 μm to about 200 μm, about 70 μm to about 200 μm, about 70 μm to about 190 μm, about 80 μm to about 180 μm, about 80 μm to about 180 μm, about 80 μm to about 160 μm, about 80 μm to about 150 μm, about 80 μm to about 140 μm, about 80 μm to about 130 μm, about 75 μm to about 85 μm, or about 80 μm to about 85 μm. In some embodiments, the depth of the channels is less than the thickness of the electrode material, with a difference in an amount of about 80 μm, about 84 μm, about 130 μm, or about 180 μm. In some embodiments, the depth of the channels is less than the thickness of the electrode material, with a difference in an amount of about 84 μm.

The specific capacity (unit Ah/g) is a measure of the amount of charge that can be reversibly stored per unit mass of electrode material. In some embodiments, at a current rate of about 3 C, the electrode of the present disclosure has a specific discharge capacity of at least about 30 mAh/g (e.g., at least about 40 mAh/g, at least about 50 mAh/g, at least about 60 mAh/g, at least about 70 mAh/g, at least about 80 mAh/g, at least about 90 mAh/g, or at least about 100 mAh/g). In some embodiments, at a current rate of about 3 C, the electrode of the present disclosure has a specific discharge capacity of from about 30 mAh/g to about 150 mAh/g (e.g., about 40 mAh/g to about 150 mAh/g, about 50 mAh/g to about 150 mAh/g, about 60 mAh/g to about 150 mAh/g, about 70 mAh/g to about 150 mAh/g, about 80 mAh/g to about 150 mAh/g, about 90 mAh/g to about 150 mAh/g, about 100 mAh/g to about 150 mAh/g, about 100 mAh/g to about 140 mAh/g, about 100 mAh/g to about 130 mAh/g, about 100 mAh/g to about 120 mAh/g, about 100 mAh/g to about 110 mAh/g, or about 100 mAh/g to about 105 mAh/g). In some embodiments, at a current rate of about 3 C, the electrode of the present disclosure has a specific discharge capacity of about 101 mAh/g.

As used herein, the areal mass loading (unit mg/cm²) of an electrode refers to the amount of active material per unit area of the electrode. The electrode has an areal mass loading of, for non-limiting example, at least about 1 mg/cm², at least about 5 mg/cm², at least about 6 mg/cm², at least about 7 mg/cm², at least about 8 mg/cm², at least about 9 mg/cm², at least about 10 mg/cm², or at least about 11 mg/cm². In some embodiments, the electrode has a mass loading of from about 1 mg/cm² to about 100 mg/cm² (e.g., about 1 mg/cm² to about 50 mg/cm², about 1 mg/cm² to about 40 mg/cm², about 1 mg/cm² to about 30 mg/cm², about 1 mg/cm² to about 20 mg/cm², about 5 mg/cm² to about 20 mg/cm², about 6 mg/cm² to about 20 mg/cm², about 7 mg/cm² to about 20 mg/cm², about 8 mg/cm² to about 20 mg/cm², about 9 mg/cm² to about 20 mg/cm², about 10 mg/cm² to about 20 mg/cm², about 10 mg/cm² to about 19 mg/cm², about 10 mg/cm² to about 18 mg/cm², about 10 mg/cm² to about 17 mg/cm², about 10 mg/cm² to about 16 mg/cm², about 10 mg/cm² to about 15 mg/cm², about 10 mg/cm² to about 14 mg/cm², about 10 mg/cm² to about 13 mg/cm², or about 10 mg/cm² to about 12 mg/cm²). In some embodiments, the electrode has a mass loading of about 11 mg/cm².

The electrode of the present disclosure comprises a current collector, which facilitates the flow of electrons between the electrode and the external circuit. For non-limiting example, the current collector is a substrate on which a composition comprising an active material (e.g., anode-active or cathode-active material) is applied. In embodiments, the composition is an electrode slurry. The composition may comprise of solid content (e.g., active material, binder, electrically conductive material), and non-solid content (e.g., solvent). The material composing the current collector may be metal in the form of, for non-limiting example, a metal foil or a metal grid. In some embodiments, the metal is nickel, titanium, aluminum, stainless steel or copper, or a combination thereof. For non-limiting example, the current collector of the cathode may be made of aluminum. For non-limiting example, the current collector of the anode may be made of copper.

Non-limiting examples of active material include compounds (e.g., metal oxides, metal phosphates) comprising Li, Ni, Mn, Co, Mg, Zn, Al, Ga, W, Zr, Ti, Ca, Ce, Fe, Y, or Nb, or a combination thereof (e.g., LiFePO₄, LiCoO₂, LiNiO₂, Li₄Ti₅O₁₂, Li₇Ti₅O₁₂ and LiMn₂O₄). In some embodiments, the active-material comprises Li, Fe, Ni, Mn, or Co, or a combination thereof. In some embodiments, the active material is LiFePO₄. The active material may be present in an amount of from about 10 wt % to about 99 wt % (e.g., about 20 wt % to about 99 wt %, about 50 wt % to about 99 wt %, about 60 wt % to about 99 wt %, about 70 wt % to about 99 wt %, about 80 wt % to about 99 wt %, about 85 wt % to about 99 wt %, or about 85 wt % to about 90 wt %) based on the total weight of the solid content of the composition. In some embodiments, the active material is present in the composition in an amount of about 87 wt % based on the total weight of the solid content of the composition.

In some embodiments, the electrode (e.g., electrode material) of the present disclosure comprises Li, Ni, Mn, Co, Mg, Zn, Al, Ga, W, Zr, Ti, Ca, Ce, Fe, Y, or Nb, or a combination thereof. In some embodiments, the electrode of the present disclosure comprises lithium or iron, or a combination thereof.

The composition (e.g., electrode slurry) applied on the current collector may further comprise binder, where the binder comprises, for non-limiting example, carboxymethyl cellulose sodium salt (CMC), styrene-butadiene rubber (SBR), polyvinylidene fluoride, polyethylene oxide, polyethylene, polypropylene, polytetrafluoroethylene, polyacrylates, or ethylene propylene diene monomer copolymer (EPDM), or a blend or copolymer thereof. In some embodiments, the binder comprises carboxymethyl cellulose sodium salt (CMC) and styrene-butadiene rubber (SBR). The binder may be present in an amount of from about 1 wt % to about 50 wt % (e.g., about 1 wt % to about 40 wt %, about 1 wt % to about 30 wt %, about 1 wt % to about 20 wt %, about 1 wt % to about 15 wt %, about 1 wt % to about 10 wt %, or about 1 wt % to about 5 wt %) based on the total weight of the solid content of the composition. In some embodiments, the binder (e.g., a blend of carboxymethyl cellulose sodium salt and styrene-butadiene rubber) is present in the composition in an amount of about 3 wt % based on the total weight of the solid content of the composition.

The composition may further comprise one or more electrically conductive materials, for non-limiting example, graphite, carbon black, carbon fibers such as graphite fibers and carbon nanotubes, metal powders such as silver powder, or metal fibers such as stainless-steel fibers and the like, or mixtures thereof. In some embodiments, the electrically conductive material is carbon black. The electrically conductive material may be present in an amount of from about 1 wt % to about 50 wt % (e.g., about 1 wt % to about 40 wt %, about 1 wt % to about 30 wt %, about 1 wt % to about 20 wt %, about 1 wt % to about 15 wt %, about 1 wt % to about 10 wt %, or about 5 wt % to about 10 wt %) based on the total weight of the solid content of the composition. In some embodiments, the electrically conductive material (e.g., carbon black) is present in the composition in an amount of about 10 wt % based on the total weight of the solid content of the composition. The one or more electrically conductive materials are different from the active materials.

In some embodiments, the composition (e.g., electrode slurry) comprises active material, electrically conductive material, and binder in a weight ratio of about 87:10:3. In one example embodiment, electrode slurry comprising a) LiFePO₄, b) carbon black, and c) CMC and SBR, are in a weight ratio of about 87:10:3. A stamping process may be used to transfer the slurry from a stamp onto a current collector. The channel pattern/structure of the resulting electrode may be modified by changing the design of the stamp.

The non-solid content of the composition comprises solvents, such as but not limited to ethylacetate, N-Methylpyrrolidine (NMP), dimethyl sulfoxide (DMSO), cyrene, y-valerolactone, or dimethylformamide (DMF), or a combination thereof. In some embodiments, the composition comprises non-solid content in an amount of from about 10 wt % to about 50 wt % (e.g., 20 wt % to about 50 wt %, 30 wt % to about 50 wt %, or about 30 wt % to about 40 wt %). In other embodiments, the composition comprises non-solid content in an amount of about 35%.

In some embodiments, the composition comprises solid content in an amount of at least about 50 wt % (e.g., at least about 55 wt %, at least about 60 wt %, at least about 65 wt %, at least about 68 wt %, at least about 70 wt %, at least about 75 wt %, or at least about 80%). In some embodiments, the composition comprises solid content in an amount of from about 50 wt % to about 90 wt %, 50 wt % to about 80 wt %, 60 wt % to about 80 wt %, or about 60 wt % to about 70 wt %. In other embodiments, the composition comprises solid content in an amount of about 65%.

The present disclosure also relates to an electrochemical cell (e.g., lithium-ion battery) comprising an electrode of the present disclosure. In some embodiments, the electrochemical cell comprises an Li-ion conducting electrolyte system. In other embodiments, the electrochemical cell comprises an electrode of the present disclosure and an Li-ion conducting electrolyte system. In embodiments, the Li-ion conducting electrolyte system contains at least one nonaqueous solvent and at least one electrolyte salt containing Li ions.

The at least one nonaqueous solvent is, for non-limiting example, N-methylacetamide, acetonitrile, carbonates, sulfolanes, sulfones, N-substituted pyrrolidones, acyclic ethers, cyclic ethers, xylene, polyethers or siloxanes, or combinations thereof. The carbonates include ethylene carbonate, ethyl methyl carbonate, fluoroethylene carbonate, methyl carbonate, ethyl carbonate and propyl carbonate; polyethers include, for example, glyme comprising diethylene glycol dimethyl ether (triglyme), tetraethylene glycol dimethyl ether (tetraglyme) and higher glyme, furthermore ethylene glycol divinyl ether, diethylene glycol divinyl ether, triethylene glycol divinyl ether, dipropylene glycol dimethyl ether and butylene glycol ether. In some embodiments, the non-aqueous solvent for the electrolyte system is ethylene carbonate (EC), ethyl methyl carbonate (EMC) or fluoroethylene carbonate (FEC), or a combination thereof.

Acyclic ethers include, for non-limiting example, dimethyl ether, dipropyl ether, dibutyl ether, dimethoxymethane, trimethoxymethane, dimethoxyethane, triethoxymethane, 1,2-dimethoxypropane and 1,3-dimethoxypropane. The cyclic ethers include tetrahydrofuran, tetrahydropyran, 2-methyltetrahydrofuran, 1, 4-dioxane, trioxane and dioxolanes.

Electrolyte salts containing Li ions include, for non-limiting example, LiPF₆, LiBF₄, LiB(C₆H₅)₄, LiSbF₆, LiAsF₆, LiClO₄, LiCF₃SO₃, Li(CF₃SO₂)₂N, LiC₄F₉SO₃, Li(CF₃SO₂)₂N, or mixtures thereof.

In some embodiments, the Li-ion conducting electrolyte system comprises LiPF₆, ethylene carbonate (EC), ethyl methyl carbonate (EMC) and fluoroethylene carbonate (FEC). In some aspects, ethylene carbonate (EC) and ethyl methyl carbonate (EMC) are present in the electrolyte system in a weight ratio of about 4:6.

Also disclosed herein are methods of forming an electrode of the present disclosure, comprising one or more of the following: a) loading a pattern (e.g., hexagonal, staggered, parallel) on a stamp surface, the pattern defining channels (e.g., microchannels) of the electrode; b) adding an electrode slurry to the stamp surface; c) pressing the stamp surface onto a current collector to transfer the electrode slurry onto the current collector; and d) drying the electrode slurry to produce an electrode material containing the channels, thereby forming the electrode comprising the current collector and the electrode material coupled to the current collector. In some embodiments, drying the electrode slurry produces an electrode material containing the channels with depth less than thickness of the electrode material. In some embodiments, the stamp pattern is a hexagonal pattern (e.g., the stamp pattern comprises extensions or protrusions, such as but not limited to cylinders, arranged in a hexagonal configuration).

In some embodiments, the stamp has a back at a location apart from the stamp surface, and adding an electrode slurry to the stamp surface comprises applying a normal force at the back of the stamp. In some aspects, the normal force applied at the back of the stamp fully compresses the slurry.

In some embodiments, the stamp of the present disclosure is a stamp roller, and pressing the stamp surface onto a current collector (e.g., to transfer electrode slurry onto the current collector) comprises using a pressure roll and a stamp roller to transfer the slurry from a stamp roller to the current collector. For non-limiting example, the stamp roller transfers the slurry from a tank to the current collector surface, and the pressure roll exerts pressure on the opposite side of the current collector, ensuring a complete transfer of the electrode slurry and control of the electrode material thickness.

For non-limiting example, the stamp pattern (e.g., surface stamp pattern) comprises cylinders having diameter of from about 1 μm to about 500 μm, about 1 μm to about 400 μm, about 1 μm to about 300 μm, about 1 μm to about 200 μm, about 10 μm to about 200 μm, about m to about 200 μm, about 30 μm to about 200 μm, about 40 μm to about 200 μm, about 50 m to about 200 μm, about 50 μm to about 190 μm, about 50 μm to about 180 μm, about 50 μm to about 170 μm, about 50 μm to about 160 μm, about 50 μm to about 150 μm, about 60 μm to about 140 μm, about 70 μm to about 130 μm, about 80 μm to about 120 μm, or about 90 μm to about 110 μm. In some embodiments, the stamp pattern comprises cylinders having diameter of of about 100 μm.

As used herein, the edge distance of the cylinders of the stamp pattern refers to the average edge-to-edge distance between adjacent cylinders of the stamp pattern. For non-limiting example, the stamp pattern comprises cylinders with an edge distance of from about 1 μm to about 500 μm, about 1 μm to about 400 μm, about 1 μm to about 300 μm, about 1 μm to about 200 μm, about 10 μm to about 200 μm, about 20 μm to about 200 μm, about 30 μm to about 200 m, about 40 μm to about 200 μm, about 50 μm to about 200 μm, about 50 μm to about 190 μm, about 50 μm to about 180 μm, about 50 μm to about 170 μm, about 50 μm to about 160 μm, about 50 μm to about 150 μm, about 60 μm to about 140 μm, about 70 μm to about 130 μm, about 80 μm to about 120 μm, or about 90 μm to about 110 μm. In some embodiments, the stamp pattern comprises cylinders with an edge distance of about 100 μm.

In some embodiments, the stamp pattern comprises cylinders having diameter of about 100 μm and edge distance of about 100 μm. In some aspects, the cylinders are hexagonally-arranged cyclinders.

### Definitions

It is to be understood that the terminology used herein is for describing particular embodiments only and is not intended to be limiting. Unless defined otherwise, all technical and scientific terms used herein have the same meaning as commonly understood by one of ordinary skill in the art to which the disclosure pertains.

Although any methods and materials similar or equivalent to those described herein may be used in the practice for testing of the present disclosure, exemplary materials and methods are described herein.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

As used in this specification and the appended claims, the singular forms “a,” “an,” and “the” include plural referents unless the content clearly dictates otherwise. The conjunctive term “and/or” between multiple recited elements is understood as encompassing both individual and combined options. For instance, where two elements are conjoined by “and/or,” a first option refers to the applicability of the first element without the second. A second option refers to the applicability of the second element without the first. A third option refers to the applicability of the first and second elements together. Any one of these options is understood to fall within the meaning, and therefore satisfy the requirement of the term “and/or” as used herein. Concurrent applicability of more than one of the options is also understood to fall within the meaning, and therefore satisfy the requirement of the term “and/or.”

Unless the context requires otherwise, throughout the specification and claims that follow, the word “comprise” and synonyms and variants thereof such as “have” and “include”, as well as variations thereof, such as “comprises” and “comprising”, are to be construed in an open, inclusive sense, e.g., “including, but not limited to.” The transitional terms “comprising,” “consisting essentially of,” and “consisting of” are intended to connote their generally accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element or step not specified in the claim; and (iii) “consisting essentially of” limits the scope of a claim to the specified materials or steps “and those that do not materially affect the basic and novel characteristic(s)” of the claimed disclosure and disclosure. Embodiments described in terms of the phrase “comprising” (or its equivalents) also provide as embodiments those independently described in terms of “consisting of” and “consisting essentially of”

“About” means within an acceptable error range for the particular value as determined by one of ordinary skill in the art, which will depend in part on how the value is measured or determined, i.e., the limitations of the measurement system. Unless explicitly stated otherwise within the disclosure, claims, result or embodiment, “about” means within one standard deviation per the practice in the art, or can mean a range of ±20%, ±10%, ±5%, ±4, ±3, ±2 or ±1% of a given value. It is to be understood that the term “about” can precede any particular value specified herein, except for particular values used in the Examples.

All percents are intended to be weight percent unless otherwise specified. The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

Those skilled in the art will recognize, or be able to ascertain, using no more than routine experimentation, numerous equivalents to the specific substances and procedures described herein. Such equivalents are intended to be encompassed in the scope of the claims that follow the examples below.

### EXAMPLE FEATURES

The following are example features of the technology described herein:
Achieving high areal energy density and fast charging of lithium-ion batteries can accelerate the adoption of electric vehicles. However, the increased mass and poor charge transfer properties of existing electrodes impede the electrochemical reaction kinetics and limit the battery charging rate. This work demonstrates a novel pattern integrated stamping process to create channels in the electrode that benefits ion transport and increases the rate performance of the electrode. Meanwhile, the pressure applied during the stamping process improved the electrode contact with the current collector and its mechanical stability. Compared to a conventional bar-coated electrode with the same electrode material thickness of 155 μm at rate 3 C, the stamped low-tortuosity LiFePO₄ electrode delivered 101 mAh/g capacity and improved cycling stability (bar-coated electrode delivered 16 mAh/g at 3 C). Furthermore, the scalable stamping method offers possibilities for industrial R2R manufacturing owing to its environmental friendliness, high efficiency, low cost, aqueous solvent, and less waste generation.

### EXAMPLE ADVANTAGES

The following are example advantages of the technology described herein:
A fast-charging and highly stable low-tortuosity electrode was fabricated using a one-step stamping process. The electrode was prepared in low cost and environmentally friendly water. The stamped electrode exhibited a high charge capacity of 101 mAh/g at a current rate of 3 C, while the bar-coated-M electrode has 54 mAh/g at 3 C with the same areal mass loading of ˜11 mg/cm², and the counterpart bar-coated-T electrode has only 16 mAh/g at 3 C with the same electrode material thickness of ˜155 μm. The EIS measurements revealed that the low-tortuosity electrode exhibited a lower resistance and better structural stability than the bar-coated electrode. Water and electrolyte contact angle characterization revealed that the low-tortuosity electrode exhibited a smaller water contact angle and faster electrolyte absorption rate than the bar-coated electrode. The stamped electrodes are straightforward and inexpensive to be fabricated and exhibited better fast-charging capability than the bar-coated electrodes. The scalability of the stamping technique makes it a promising industrial manufacturing process for low-tortuosity fast-charging electrodes. This work provides innovative and feasible strategies for developing fast-charging electrodes for practical applications in battery technology.

### EXAMPLE USES

The following are example uses of the technology described herein:
Electrode manufacturing, e.g., battery electrode manufacturing, and/or
Energy storage.

### EXAMPLES

### Example 1: Efficient Manufacturing of Low-Tortuosity Fast-Charge Electrodes Through One-Step Stamping Process

Example 1 was published in Energy Environ. Mater. 2023, 6, e12584, which is incorporated herein by reference in its entirety.

Achieving high energy density and fast charging in lithium-ion batteries is expected to accelerate the mass-market adoption of electric vehicles. Herein is presented a novel highly-stable low-tortuosity electrode for fast-charging lithium-ion batteries fabricated using a one-step stamping process. The stamping process introduced channels in the electrode material that accelerated the ion transport and increased the rate performance of the electrode. In addition, the pressure applied during the stamping process improved the mechanical stability of the electrode and its contact with the current collector.

For the first time, low-tortuosity structure electrodes were fabricated using a one-step stamping process, and rate performance, cycling stability and mechanical structure stability of the electrodes were investigated. Compared with currently available technologies, the one-step stamping process achieves rapid fabrication of low-tortuosity structure electrode. Moreover, the stamping method offers unparalleled possibilities for industrial applications, owing to its simplicity, scalability, low cost and solvent consumption, and waste reduction.

The stamped low-tortuosity electrode with the thickness of 155 μm exhibited an impressive capacity of 101 mAh/g at a charge-discharge rate of 3 C. It delivers a high capacity of 110 mAh/g with a capacity retention rate of 78.0% after 50 cycles at 1 C. The stamped electrode also exhibited superior electrolyte wettability and mechanical structure stability compared to the conventional electrode.

Materials: LiFePO₄ (LFP) was purchased from Fisher and coated with 2 weight percent (wt. %) carbon. Carboxymethyl cellulose sodium salt (CMC) with an average molecule weight of 250,000 g/mol was purchased from Thermo Scientific™. Styrene-butadiene rubber (SBR) solvent (solid content of 50 wt. %) was purchased from MTI. Carbon black (CB, Super P) was purchased from TIMCAL. All materials were used as received.

Preparation of the LiFePO₄ cathode slurry: Binder was obtained by mixing the CMC powder and SBR solvent with deionized (DI) water under a 1:1 solid mass ratio. To enhance the conductivity of LFP, Super P was ground first, then mixed with LFP for 10 minutes at 3500 rpm to ensure good contact between the active material and conductive carbon. Binder and DI water were added (LiFePO₄:Super P:Binder=87:10:3, Solid content=65 wt. %) and mixed for 30 minutes at 3500 rpm. All the mixing steps were finished by a dual asymmetric centrifugal mechanism (DAC 330-100 Pro Speedmixer from FlakTek).

Electrode preparation: The Al foil was punched into a 19 mm diameter circle as a substrate for the stamp. Daubed the electrode slurry to the stamp pattern surface and stamped it onto the prepared current collector. Starting from one end, the electrode with low-tortuosity structure can be obtained after the stamp is completely separated. Meanwhile, the traditional bar-coating technology was applied to fabricate the control sample to evaluate the advantages of the stamped low-tortuosity electrode. Dispersed electrode slurry with a solid content of 40 wt. % was coated with a thickness of 500 μm. The thickness of the bar-coated electrode material after drying is 150 μm.

Battery assembly: The electrodes were punched to small discs with diameter of 6.5 mm. Before being transferred into the glove box, all materials were dried in a 100° C. vacuum oven for 12 hours to eradicate moisture. All assembly steps were finished in the glove box with water content below 0.01 ppm. Lithium metal slice with a diameter of 8 mm was used as anode in the battery assembly. The battery shell was coin battery 2025 (from AME), and the thickness of the spacer was 0.8 mm. According to the installation, the order was cathode shell, cathode, separator (Celgard 2400, thickness in 25 μm), anode (lithium metal foil, diameter in =8 mm), spacer, spring, and anode shell. A total of 80 μl electrolyte (1M LiPF₆ dissolved in ethylene carbonate (EC):ethyl methyl carbonate (EMC)=4:6 with 3% fluoroethylene carbonate (FEC)) was dropped into the battery in two parts. Afterward, the battery was sealed in a crimping machine at a pressure of 500 kg/cm² for 10 seconds.

Characterization methods: The morphology of the samples was characterized by using scanning electron microscopy (SEM, Hitachi S4800 SEM) at 3 kV. The stamped low-tortuosity electrodes were broken to prepare the cross-section SEM samples, as the blade would disrupt the structure of the low-tortuosity structure. High-magnification images were taken from the edges of the stamped electrode channel to investigate the effect of the stamping technique on the distribution of the material. The contact angle and electrolyte absorb time were investigated by the optical contact angle measuring instrument (SDC-350, SINDIN). The shooting time interval was 100 ms and lasted for 30 seconds.

Electrochemistry characterization: The battery was placed at room temperature for 10 hours to ensure the fully infiltrate of the electrolyte. Galvanostatic tests were performed using Land Battery Measurement System (CT2001A, Land, China). In the voltage range of 2.5 to 4V, the current rate is set according to the experiment. Electrochemical impedance spectroscopy was performed using Biologic SP 150 potentiostat in the frequency range of 1-100 MHz, and cyclic voltammetry was performed using Biologic MPG2 at a scan rate of 0.1 mV/s.

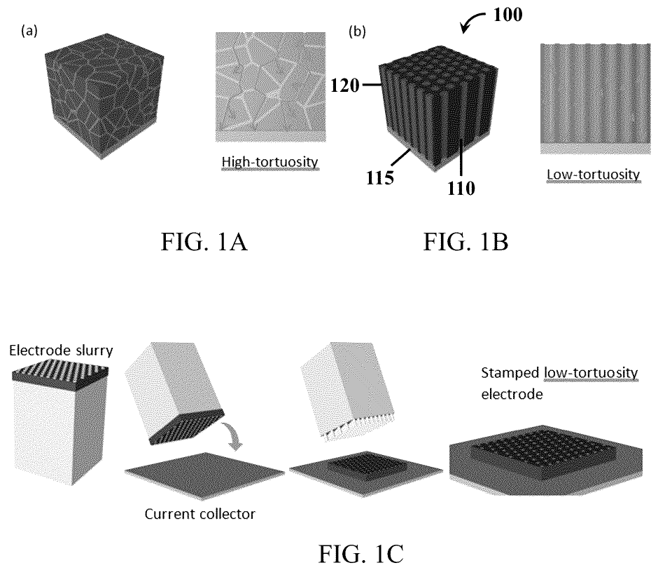

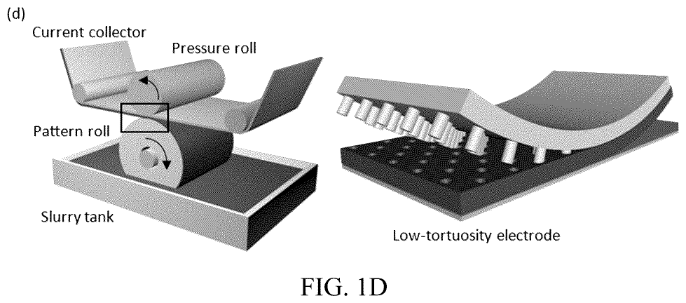

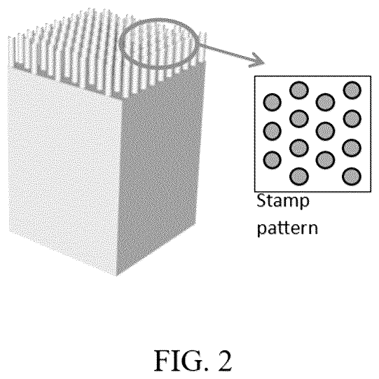

Results and Discussion. For conventional electrodes, random, tight stacking of the electrode material particles results in a circuitous pore structure (FIG. 1A). The resulting high-tortuosity path hinders electrolyte penetration into the electrode and significantly increases the ion-transfer distance. As shown in an example embodiment of the present disclosure illustrated in FIG. 1B, a low-tortuosity structure of the electrode 100 (comprising electrode material 120 and current collector 115) can improve the electrode accessibility to the electrolyte and shorten the ion-transfer path along channels 110 during battery charge and discharge. This, in turn, can accelerate the transport of lithium ions between the electrolyte and electrode. FIG. 1C shows the fabrication process of the stamped low-tortuosity electrode. To ensure complete separation, after applying the vertical pressure to the back of the stamp, the stamp was maintained stable for 30 seconds to operate an initial drying for the slurry. After the dryness, a tiny space formed between the slurry surface and the stamp pattern. The slurry around the stamp was then cleaned to provide a channel for the atmosphere entry to aid in the separation between slurry and stamp. The surface pattern of the stamp consisted of hexagonally-packed cylinders of diameter 100 μm separated by 100 μm gaps, as shown in FIG. 2. After adding an electrode slurry to the stamp surface, the loaded stamp was pressed onto the current collector. A normal force was applied at the back of the stamp to fully compress the slurry and ensure conformal contact with the collector. The subsequent withdrawal of the stamp resulted in a low-tortuosity electrode structure formed on the surface of the current collector. The thickness and porosity of the electrode material are controlled by the stamping pressure, amount of slurry loaded onto the stamp, and solid content of the slurry.

This stamping technique can be scaled up and integrated into existing R2R processes for the industrial manufacturing of low-tortuosity electrodes. The schematic of the R2R stamping, shown in FIG. 1D, highlights the two main processes: pattern rolling and pressure rolling. In industrial R2R fabrication, the pattern roll (e.g., stamp roller) transfers the slurry from a tank to the current collector surface. The pressure roll exerts pressure on the opposite side of the current collector, ensuring a complete transfer of the electrode slurry and control of the electrode material thickness.

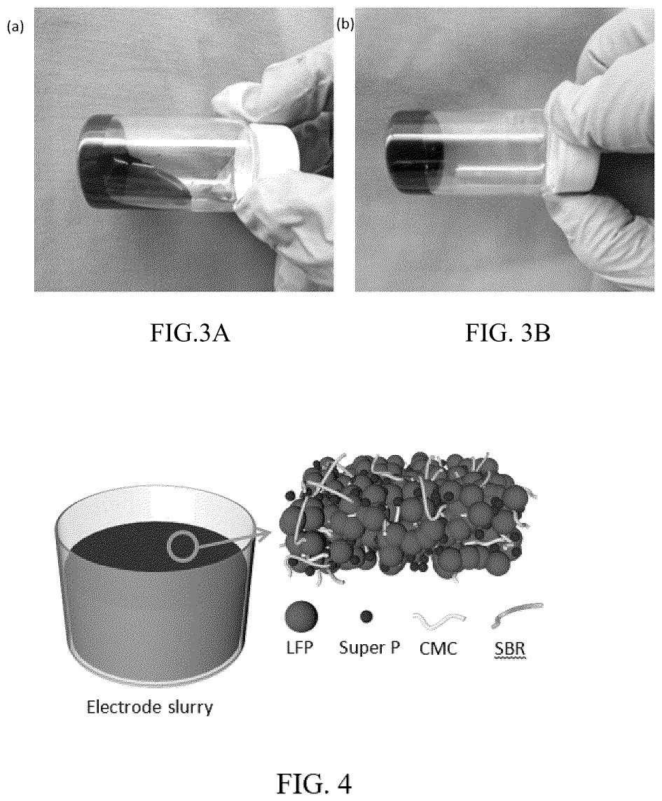

Optimizing the slurry composition is crucial for ensuring successful stamping of low-tortuosity electrodes. In this study, the stamping performance of slurries with a solid content of 40 and 65 wt. % were compared. FIG. 3A-B show photographs of the two different as-prepared slurries. Lithium iron phosphate (LiFePO₄, LFP), carbon black (CB, Super P), and a mixture of carboxymethyl cellulose sodium salt (CMC) and styrene-butadiene rubber (SBR) were used as the active material, electrically conductive material, and electrode binder, respectively (LiFePO₄:Super P:CMC/SBR=87:10:3) (FIG. 4). The prepared 40 and 65 wt. % slurries were placed into vials and stored vertically until they had completely settled. The vials were then rotated at 180° horizontally and observed to estimate the slurry viscosity. The slurry with 65 wt. % solid content was highly viscous and firmly stuck to the bottom of the vial. The viscosity of the slurry with 40 wt. % solid content appeared to be too low and unsuitable for stamping.

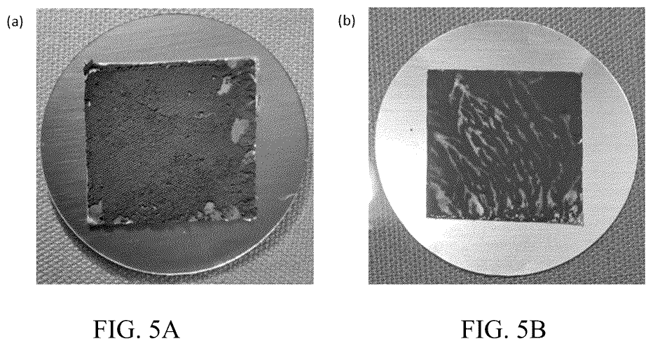

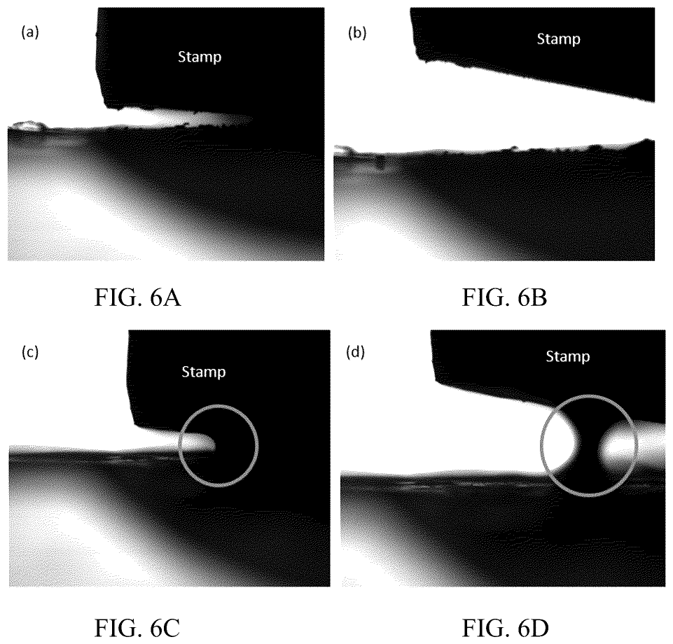

Both slurries were stamped onto a current collector, and the resulting morphologies are shown in FIG. 5A-B. The electrode structure fabricated using low-solid-content slurry appeared as a tree branch, which was caused by the tendency of the slurry to stick to the stamp surface during the separation. The electrode fabricated using high-solid-content slurry exhibited a well-defined pore structure corresponding to the stamp pattern. High-speed imaging data (FIG. 6A-D) enabled the study of the slurry behavior during the stamping process. In the case of the high-solid-content slurry, the stamp separated easily from the electrode without any slurry residue. When stamping using the low-solid-content slurry, a curved slurry bridge was formed between the stamp and current collector, as shown in FIG. 6D, which prevented the clean separation of the two parts.

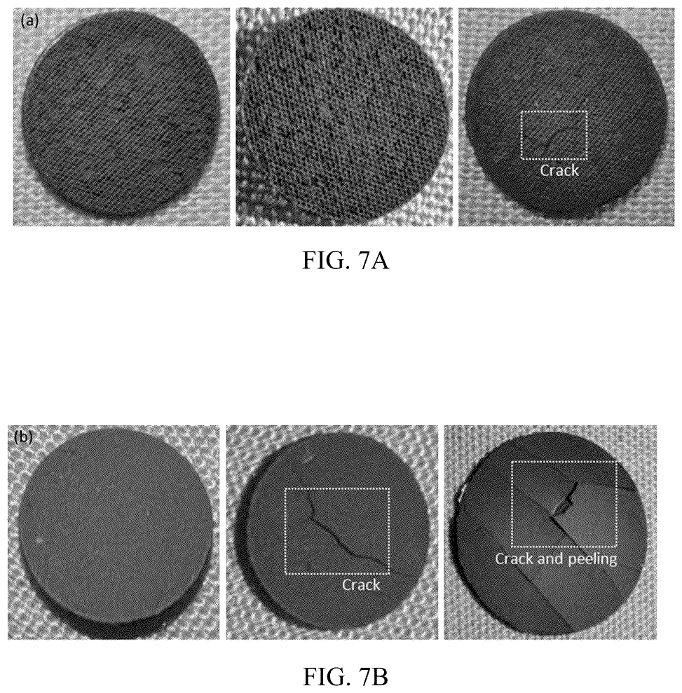

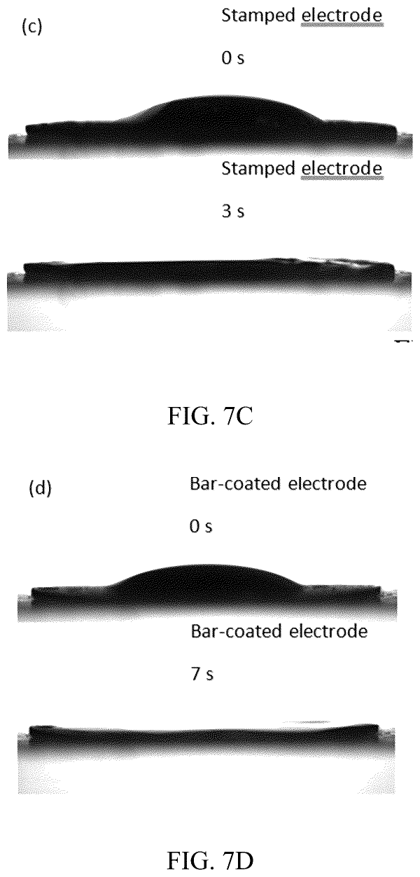

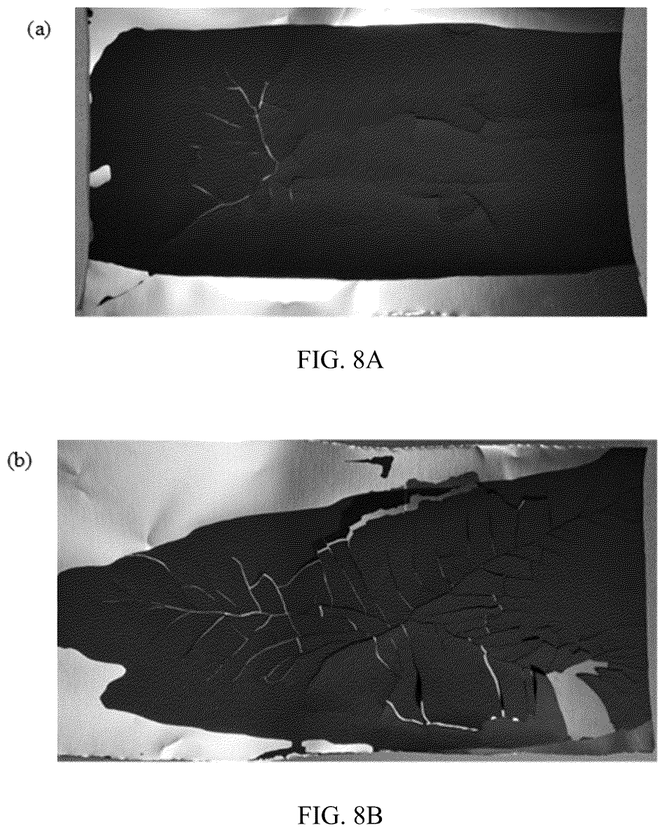

The stamped electrode exhibited better structural stability even at larger electrode material thickness compared to bar-coated electrodes, which can improve the cycling stability of electrodes with higher mass loading. FIGS. 7A and B show stamped and bar-coated electrodes, respectively, of electrode material thickness 150, 200, and 250 μm. At electrode material thickness of 150 μm, both types of electrodes remained intact and in close contact with the current collector. As the electrode material thickness of the bar-coated electrode increased to 200 m, cracks began to appear on the electrode surface. Further increase of the electrode material thickness to 250 μm resulted in prominent cracks and flaking of the electrode material. FIG. 8A-B show the dried bar-coated electrodes of electrode material thicknesses 200 μm and 250 μm before punching, the electrodes had developed visible cracks when they were drying. In contrast, there were no observable cracks in the 200 μm-thick stamped electrode and only a minor crack in the 250 μm-thick electrode. The applied pressure during the stamping process enhanced the contact between the electrode particles, resulting in better adhesion between the electrode and current collector and improved integrity of the electrode material at larger thickness. In addition, the channels on the stamped electrode surface also facilitated the moisture evaporation and provided a surplus space for electrode volume deformation during the drying process, thus preserving the structural integrity of the stamped electrode.

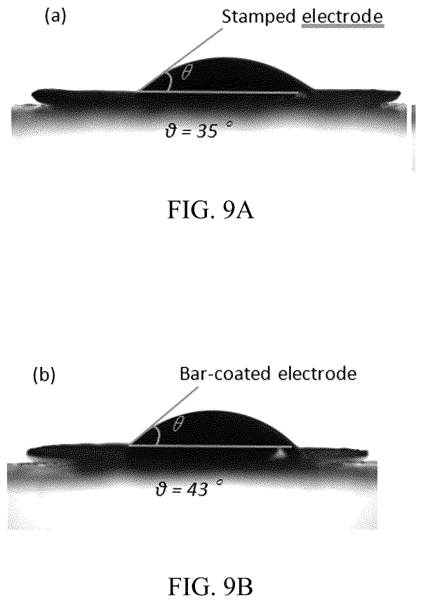

Improving the electrolyte wettability of the electrode is of particular importance for the development of fast-charging batteries. Electrodes with poor wettability produce unstable solid-electrolyte interface film, which hinders the redox reaction and degrades the performance of the electrode. Owing to the rapid electrolyte absorption by the electrode, measuring the contact angle between the electrode and electrolyte accurately was difficult. Hence, the rate of electrolyte absorption by the electrode was measured to evaluate the electrolyte wettability of the electrode. As shown in FIG. 7C, the stamped electrode required 3 seconds to fully absorb 2 μl of the electrolyte. In contrast, the electrolyte droplet completely permeated the bar-coated electrode after 7 seconds (FIG. 7D). The observed faster electrolyte absorption by the stamped electrode indicates better electrolyte wettability compared to the bar-coated electrode. FIGS. 9A and B show the water contact angles of the stamped and bar-coated electrodes, respectively, one second after the water droplet deposition. The contact angle of the stamped electrode was 35°, which is smaller than the contact angle of 43° exhibited by the bar-coated electrode. For hydrophilic surfaces, the increased roughness and porosity of the surface result in a smaller interfacial water contact angle.^{[14]} As the surfaces of both electrodes are hydrophilic, the smaller water contact angle of the stamped electrode can be attributed to its higher surface roughness.

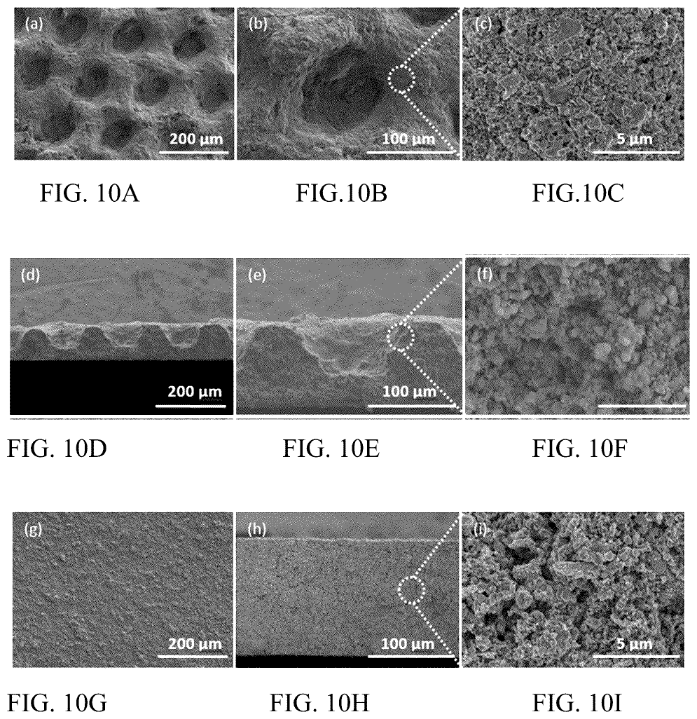

The scanning electron microscopy (SEM) images in FIG. 10A-I show the microstructure of the stamped and bar-coated electrodes. FIGS. 10A and B represent top-view SEM images of the stamped low-tortuosity electrode, which exhibits a rough surface decorated with micrometer-sized channels arranged in a “honeycomb” pattern, consistent with the stamp pattern. The microchannels had a tapered shape with a top diameter of 120 μm, as shown in the cross-sectional SEM images (FIGS. 10D and E). The channel depth was 71 μm, which is less than the electrode material thickness (155 μm), because of the material buildup during the drying process and uneven pattern surface. FIGS. 10G and H represent the top-view and cross-sectional images of the bar-coated electrode, respectively. The electrode surface appeared rough with tightly-packed electrode particles, suggesting that the highly-tortuous paths formed in the electrode material are the only available ion transport route. To investigate the effect of the stamping method on the particle distribution in the electrode material, high-magnification SEM images were acquired at the channel edge of the stamped electrode (FIGS. 10C and F) and compared with the images of the bar-coated electrode (FIG. 10I). The LFP and CB particles were distributed similarly in both electrodes, indicating that the stamping process had no observable effect on the electrode material distribution and interconnection of LFP and CB.

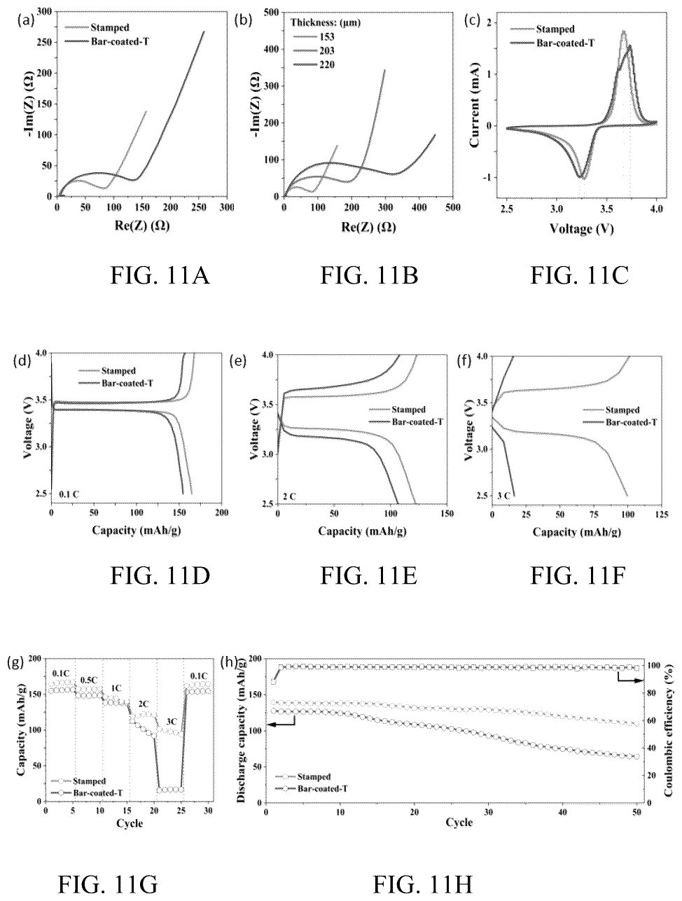

The bar-coated electrode with same electrode material thickness (bar-coated-T electrode) as stamped electrode assembled for the electrochemical characterization as the control sample. To study the battery interface stability, two batteries assembled using bar-coated-T and stamped electrodes were investigated by electrochemical impedance spectroscopy (EIS). FIG. 11A shows Nyquist plots of the two electrodes. The semicircular patterns in the high-frequency region are clear, and the diameter of the semicircles represents the charge resistance of the two electrodes. The EIS results show smaller resistance of the stamped electrode in the high- and medium-frequency regions compared to that of the bar-coated-T electrode, confirming the improved charge transfer kinetics of the stamped electrode. The enhanced performance can be attributed to the lower tortuosity of the stamped structure, which provides a larger electrode/electrolyte contact area and improves the charge transfer kinetics at the electrode interface. To investigate the effect of the electrode material thickness on the electrode interface resistance, EIS measurements were performed on stamped electrodes of different electrode material thickness. The diameters of the high-frequency semicircles in the Nyquist plots, shown in FIG. 11B, gradually increased with the increase in the electrode material thickness. For thick electrodes, the ion transfer rate is the main factor limiting the charge transfer process.^{[15]} As the electrode material thickness increased, the mass transfer rate of the electrode decreased, and its charge transfer resistance increased. FIG. 11C shows the cyclic voltammetry (CV) curves of the stamped and bar-coated-T electrodes. The stamped electrode showed a narrower spread of the redox peaks than the bar-coated-T electrode, indicating better electrochemical kinetic behavior in the stamped electrode.

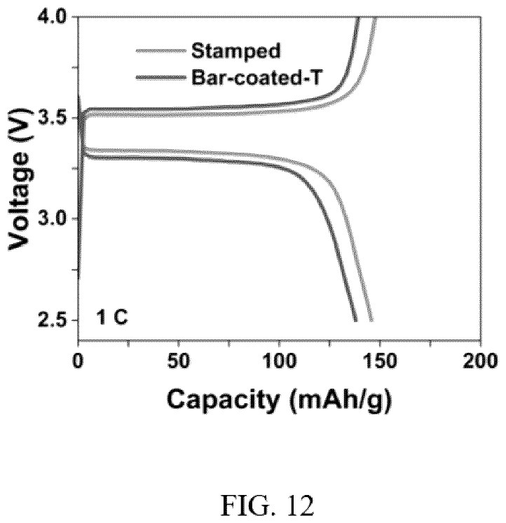

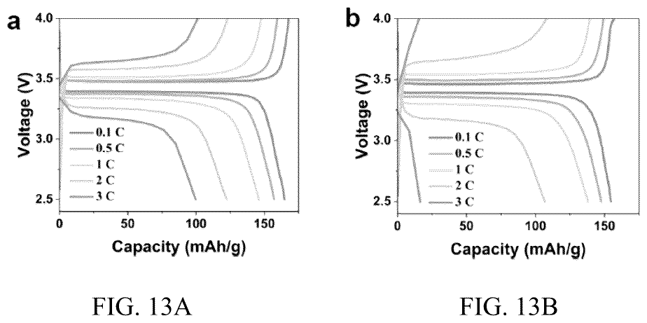

The charge and discharge profiles of the stamped and bar-coated-T electrodes at current rates of 0.1 C, 1 C, 2 C, and 3 C are shown in FIGS. 11D-F and FIG. 12. Both electrodes showed a flatter voltage plateau around 3.5 V at 0.1 C. As the current rate increased, the voltage plateau of the stamped electrode shifted slightly to approximately 3.6 V at 3 C, whereas the voltage plateau of the bar-coated-T electrode increased dramatically. The potential of the two batteries was compared at 50% of the state of charge and depth of discharge to evaluate the electrochemical reaction kinetics. At charge-discharge current rates of 2 and 3 C, which are displayed in FIGS. 11E and F, the overpotential of the bar-coated-T electrode battery was significantly higher, confirming the lower reaction kinetics and worse rate performance of the bar-coated-T electrode battery^{[16]}. FIG. 13A-B show the voltage profile for the third cycle at different current rates ((a): stamped electrode, (b): bar-coated electrode). As the current rate increased from 0.1 C to 3 C, the voltage plateau of the stamped electrode shifted slightly, whereas the voltage plateau of the bar-coated-T electrode increased dramatically.

FIG. 11G shows the specific capacities of the stamped electrode of electrode material thickness 155 μm and the bar-coated-T electrode of electrode material thickness 156 μm. At a current rate of 0.1 C, the average capacity of the stamped electrode was 172 mAh/g, with a charge capacity of 101 mAh/g at a current rate of 3 C. Notably, when the current rate increased from 0.1 C to 1 C, no apparent decrease in the capacity was observed, which demonstrates the excellent rate performance of the stamped electrode. Under the same conditions, the average discharge capacity of the bar-coated-T electrode was 160, 151, 140, 107, and 16 mAh/g at current rates of 0.1, 0.5, 1, 2, and 3 C, respectively. Table 1 provides the current densities (unit: mA/cm²) for stamped and bar-coated-M electrodes for different current rates.

TABLE 1

| | Current rate | | | | |
|---|---|---|---|---|---|
| Sample | 0.1 C | 0.5 C | 1 C | 2 C | 3 C |
| Stamped electrode | 0.18 | 0.90 | 1.80 | 3.60 | 5.40 |
| Bar-coated-M electrode | 0.19 | 0.96 | 1.92 | 3.85 | 5.78 |

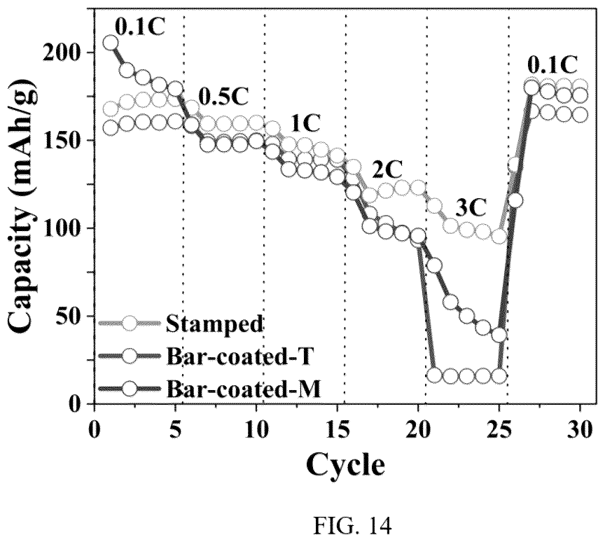

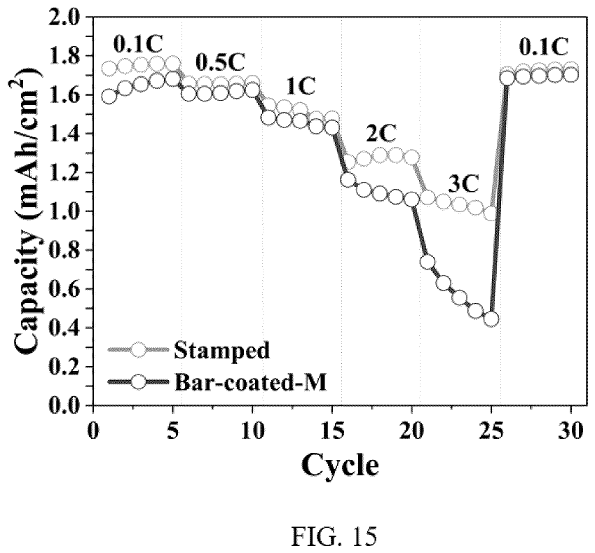

Upon reducing the current rate to 0.1 C, the discharge capacity of both electrodes recovered to the initial value. To further illustrate the stamped electrode rate performance, another bar-coated electrode assembled using the same active material mass loading (bar-coated-M) as stamped electrode was investigated. FIG. 14 shows the measured charge capacities of three electrodes. The stamped electrode exhibited more favorable charge capacity over a wide range of current rate than the bar-coated electrode under the same electrode material thickness or active material mass loading. FIG. 15 shows the areal capacities of the stamped and bar-coated-M electrodes. The results demonstrate that the stamped low-tortuosity electrode structure exhibits better fast-charging performance compared to the bar-coated electrode. The improved rate performance of the stamped electrode can be attributed to the uniformly-aligned channels, which reduce the lithium-ion transport distance between the cathode and the separator, thus increasing the ionic current.

The long-term cycling performance of both electrodes was evaluated at a current rate of 1 C. As shown in FIG. 11H, both electrodes maintained approximately 98% coulombic efficiency over 50 cycles. The stamped electrode battery exhibited superior stability compared to the bar-coated-T electrode battery. After 50 cycles, the capacity of both batteries decayed, with the stamped electrode battery maintaining 78.0% of its original capacity (109 mAh/g), whereas the capacity of the bar-coated electrode battery rapidly decayed to 50.6% (64 mAh/g).

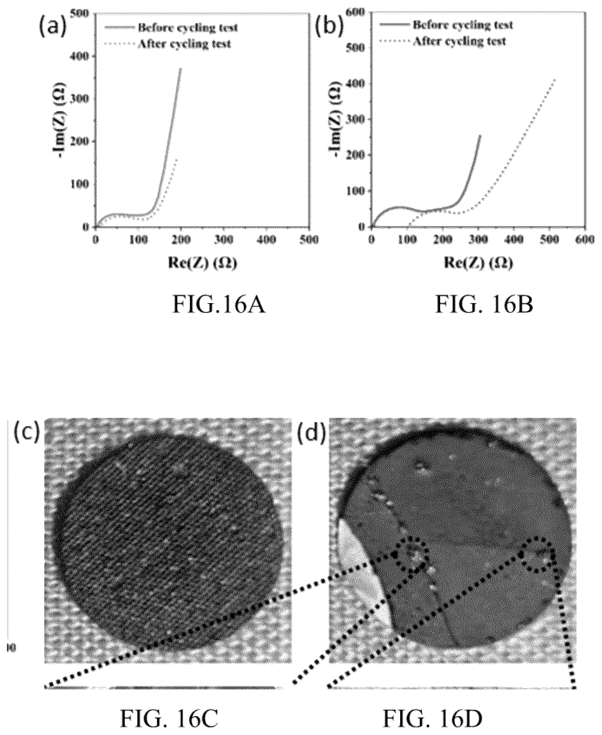

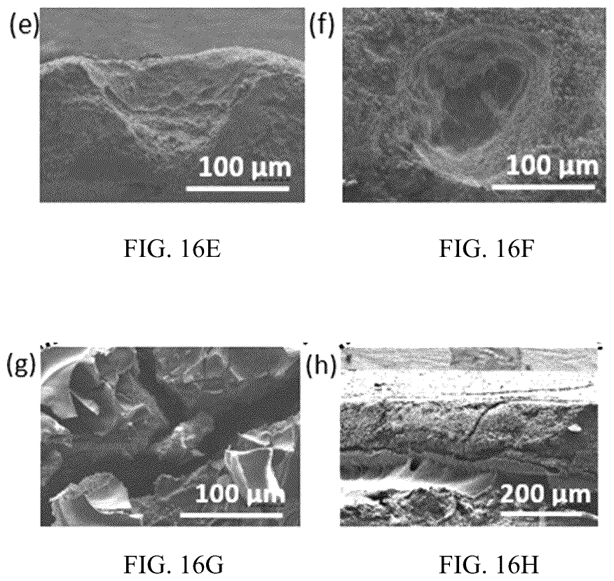

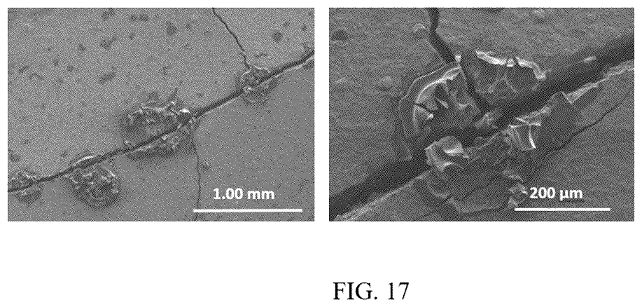

The EIS measurements were repeated after the cycling tests to investigate the stability of the stamped electrode. As shown in FIG. 16A, the Nyquist plot of the stamped electrode did not change significantly after the cycling, indicating excellent electrode cycle stability. In the case of the bar-coated-T electrode (FIG. 16B), the intercept of the Nyquist curve with Re(Z) and the diameter of the semicircle increased after the cycling test. The results indicated decayed electrical connectivity of the bar-coated-T electrode, most likely due to the cracking and flaking of the electrode material, potentially leading to unstable contact between the electrode and current collector. To verify this hypothesis, following the long cycle test, the batteries were disassembled to investigate the changes in the electrode structure. The stamped electrode remained intact with no observable cracks or material loss (FIG. 16C). In contrast, two cracks spanning the entire bar-coated-T electrode and some missing electrode material were observed, exposing the current collector underneath it. In addition to the cracks, prominent protrusions across the electrode surface were observed, as shown in FIG. 16D. The top-view and cross-sectional images of the stamped electrode (FIGS. 16E and F) showed no collapse or cracking of the microchannels, confirming the excellent structural stability of the low-tortuosity electrode during the cycling process. The bar-coated-T electrode showed significant cracking after the long cycle testing (FIG. 16G). The cross-sectional view (FIG. 16H) showed that the electrode was interspersed with cracks and some material was detached from the current collector. The protrusions along the cracks in the bar-coated-T electrode, shown in FIGS. 17A and B, can cause uneven ion distribution during the battery charge-discharge, which may result in battery short circuit affecting the battery safety. In addition, the electrode material that detached from the current collector could no longer participate in the charge-discharge process, resulting in a rapid capacity decrease.

Conclusion. In conclusion, a fast-charging and highly stable low-tortuosity electrode was fabricated using a one-step stamping process. The stamped electrode cell exhibited a high charge capacity of 101 mAh/g at a current rate of 3 C, while the bar-coated M electrode has 54 mAh/g at 3 C with the same areal mass loading of ˜11 mg/cm², and the counterpart bar coated electrode has only 16 mAh/g at 3 C with the same electrode material thickness of ˜155 μm. The EIS measurements revealed that the low-tortuosity electrode exhibited a lower resistance and better cycling stability than the bar-coated electrode. Water and electrolyte contact angle measurements revealed that the low-tortuosity electrode exhibited a smaller water contact angle and faster electrolyte absorption rate than the bar-coated electrode.

The stamped electrodes were easy and inexpensive to fabricate and exhibited better fast-charging capability than the bar-coated electrodes. The scalability of the stamping technique makes it a promising fabrication method for low-tortuosity fast-charging electrodes. Other methods, such as magnetic alignment and laser perforation, can produce electrodes with comparable tortuosity. However, the high cost associated with the introduction and elimination of magnetic additives and the slow fabrication process limit the large-scale industrial application of these methods. This work provides insights into the development of fast-charging electrodes for practical applications in battery technology.

### REFERENCES

[1] a) N. Nitta, F. Wu, J. T. Lee, G. Yushin, Materials Today 2015, 18, 252; b) A. J. Smith, J. C. Burns, J. R. Dahn, Electrochemical and Solid-State Letters 2010, 13; c) Y. Wang, D. Cao, X. Sun, H. Ren, T. Ji, X. Jin, J. Morse, B. Stewart, H. Zhu, Advanced Materials Technologies 2022.
[2] A. Tomaszewska, Z. Chu, X. Feng, S. O'Kane, X. Liu, J. Chen, C. Ji, E. Endler, R. Li, L. Liu, Y. Li, S. Zheng, S. Vetterlein, M. Gao, J. Du, M. Parkes, M. Ouyang, M. Marinescu, G. Offer, B. Wu, eTransportation 2019, 1.
[3]Y. Liu, Y. Zhu, Y. Cui, Nature Energy 2019, 4, 540.
[4] C. Huang, M. Dontigny, K. Zaghib, P. S. Grant, Journal of Materials Chemistry A 2019, 7, 21421.
[5]K. G. Gallagher, S. E. Trask, C. Bauer, T. Woehrle, S. F. Lux, M. Tschech, P. Lamp, B. J. Polzin, S. Ha, B. Long, Q. Wu, W. Lu, D. W. Dees, A. N. Jansen, Journal of The Electrochemical Society 2015, 163, A138.
[6]Y. Kuang, C. Chen, D. Kirsch, L. Hu, Advanced Energy Materials 2019, 9.
[7] a) E. R. Logan, J. R. Dahn, Trends in Chemistry 2020, 2, 354; b) J. Popovic, D. Hofler, J. P. Melchior, A. Munchinger, B. List, J. Maier, J Phys Chem Lett 2018, 9, 5116; c) G. Li, Z. Liu, Q. Huang, Y. Gao, M. Regula, D. Wang, L.-Q. Chen, D. Wang, Nature Energy 2018, 3, 1076; d) C. Chen, Y. Zhang, Y. Li, Y. Kuang, J. Song, W. Luo, Y. Wang, Y. Yao, G. Pastel, J. Xie, L. Hu, Advanced Energy Materials 2017, 7.
[8] a) X. Gao, X. Liu, R. He, M. Wang, W. Xie, N. P. Brandon, B. Wu, H. Ling, S. Yang, Energy Storage Materials 2021, 36, 435; b) X. Wang, T. Wang, J. Borovilas, X. He, S. Du, Y. Yang, Nano Research 2019, 12, 2002; c) I. V. Thorat, D. E. Stephenson, N. A. Zacharias, K. Zaghib, J. N. Harb, D. R. Wheeler, Journal of Power Sources 2009, 188, 592.
[9]J. S. Sander, R. M. Erb, L. Li, A. Gurijala, Y. M. Chiang, Nature Energy 2016, 1.
[10]S. Wu, H. Zheng, X. Wang, N. Zhang, W. Cheng, B. Fu, H. Chen, H. Liu, H. Duan, Chemical Engineering Journal 2022, 430.
[11]D. Cao, Y. Xing, K. Tantratian, X. Wang, Y. Ma, A. Mukhopadhyay, Z. Cheng, Q. Zhang, Y. Jiao, L. Chen, H. Zhu, Adv Mater 2019, 31, e1807313.
[12]L. L. Lu, Y. Y. Lu, Z. J. Xiao, T. W. Zhang, F. Zhou, T. Ma, Y. Ni, H. B. Yao, S. H. Yu, Y. Cui, Adv Mater 2018, 30, e1706745.
[13] a) T. Marks, S. Trussler, A. J. Smith, D. Xiong, J. R. Dahn, Journal of The Electrochemical Society 2011, 158; b) H. Zheng, L. Tan, G. Liu, X. Song, V. S. Battaglia, Journal of Power Sources 2012, 208, 52.
[14]E. Bormashenko, Adv Colloid Interface Sci 2015, 222, 92.
[15]K.-Y. Park, J.-W. Park, W. M. Seong, K. Yoon, T.-H. Hwang, K.-H. Ko, J.-H. Han, Y. Jaedong, K. Kang, Journal of Power Sources 2020, 468.
[16]Z. Chen, D. L. Danilov, L. H. J. Raijmakers, K. Chayambuka, M. Jiang, L. Zhou, J. Zhou, R.-A. Eichel, P. H. L. Notten, Journal of Power Sources 2021, 509.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments.

What is claimed is:

1. An electrode, comprising:
a current collector; and
an electrode material coupled to the current collector, the electrode material containing microchannels and depth of microchannels is less than thickness of the electrode material.

2. The electrode of claim 1, wherein the electrode material has a hydrophilic surface with a water contact angle equal to or less than about 60°.

3. The electrode of claim 1, wherein the depth of the microchannels is from about 50 μm to about 150 μm.

4. The electrode of claim 1, wherein diameter of the microchannels is from about 50 μm to about 150 μm.

5. The electrode of claim 1, wherein diameter of the microchannels is about 120 μm and depth of the microchannels is about 71 μm.

6. The electrode of claim 1, wherein the electrode has a specific discharge capacity of at least about 90 mAh/g at a current rate of about 3 C.

7. The electrode of claim 1, wherein the electrode has an areal mass loading of at least about 10 mg/cm².

8. The electrode of claim 1, wherein the thickness of the electrode material is equal to or less than about 250 μm.

9. A method of forming an electrode, comprising:
a) loading a pattern on a stamp surface, the pattern defining microchannels of the electrode;
b) adding an electrode slurry to the stamp surface;
c) pressing the stamp surface onto a current collector to transfer the electrode slurry onto the current collector; and
d) drying the electrode slurry to produce an electrode material containing the microchannels with depth less than thickness of the electrode material;
thereby forming the electrode comprising the current collector and the electrode material coupled to the current collector.

10. The method of claim 9, wherein the stamp has a back at a location apart from the stamp surface, and wherein adding the electrode slurry to the stamp surface comprises applying a normal force at the back of the stamp.

11. The method of claim 9, wherein the pattern is a hexagonal pattern.

12. The method of claim 9, wherein the pattern comprises cylinders having diameter of from about 50 μm to about 150 μm.

13. The method of claim 9, wherein the stamp is a stamp roller and wherein pressing the stamp surface onto the current collector comprises using a pressure roll and the stamp roller to transfer the slurry from the stamp roller to the current collector.

14. The method of claim 9, wherein solid content of the slurry is from about 60% to about 70%.

15. The method of claim 9, wherein material composing the current collector is stainless steel, titanium, aluminum, nickel, or copper, or a combination thereof.

16. An electrode slurry, comprising active material, electrically conductive material, and binder.

17. The slurry of claim 16, wherein the active material comprises LiFePO₄.

18. The slurry of claim 16, wherein solid content of the slurry is from about 60% to about 70%.

19. The slurry of claim 16, wherein the electrically conductive material is carbon black, and wherein the binder comprises carboxymethyl cellulose sodium salt (CMC) and styrene-butadiene rubber (SBR).

20. The slurry of claim 16, wherein the active material, electrically conductive material, and binder are in a weight ratio of about 87:10:3.
